(19) United States
(12) Patent Application Publication
(10) Pub. No.: US 2019/0299718 A1
(43) Pub. Date: Oct. 3, 2019

(54) Reinforcing layer for objects made of an elastomeric material, preferably for pneumatic vehicle tyres and pneumatic vehicle tyres

(71) Applicant: Continental Reifen Deutschland GmbH, Hannover (DE)

(72) Inventors: Wolfgang Reese, Peine (DE); Thomas Kramer, Herford (DE)

(73) Assignee: Continental Reifen Deutschland GmbH, Hannover (DE)

(21) Appl. No.: 16/307,947

(22) PCT Filed: May 16, 2017
(86) PCT No.: PCT/EP2017/061674

§ 371 Date: Dec. 7, 2018

(30) Foreign Application Priority Data
Jun. 9, 2016 (EP) 16173675.6

(51) Int. Cl. B60C 9/00; B60C 15/06; D02G 3/48; D02G 3/04; D07B 1/02

(52) U.S. Cl. CPC B60C 9/0042; B60C 15/0632; B60C 15/0635; D02G 3/48; D07B 2501/2046; D07B 1/025; B60C 2015/0689; B60C 2009/0092; B60C 2009/0078; D02G 3/045

(57) ABSTRACT

The invention relates to a rubberized reinforcing ply for articles composed of elastomeric material, preferably for vehicle tires, wherein the reinforcing ply has a multiplicity of strengthening elements which are in parallel and spaced apart, wherein each strengthening element is a cord which is end-twisted from at least two twisted multifilament yarns composed of polyamide 6.6. The raw yarn composed of polyamide 6.6 has a tenacity which, at an elongation of 4%, is within a range from 1.35 cN/dtex to 1.60 cN/dtex, the cord has a tenacity which, at an elongation of 4%, is within a range from 1.2 cN/dtex to 2 cN/dtex and the cord has a thermal shrinkage at 177° within a range of 4.0%-7.0%, wherein the tenacity in accordance with ASTM D885-16 and the thermal shrinkage at 177° C. are determined under a pre-tension of 0.045 g/dtex with an exposure time of two minutes.

The invention relates to a rubberized reinforcing ply for articles composed of elastomeric material, preferably for vehicle tires, wherein the reinforcing ply has a multiplicity of strengthening elements which are in parallel and spaced apart, wherein each strengthening element is a cord which is end-twisted from at least two twisted multifilament yarns composed of polyamide 6.6. The invention further relates to a pneumatic vehicle tire comprising this reinforcing ply.

Reinforcing plies for articles made of elastomeric material such as, for example, industrial rubber products and (pneumatic) vehicle tires are of very great importance and are general knowledge to the person skilled in the art. The reinforcing plies have a multiplicity of reinforcing, thread-shaped elements, referred to as the strengthening elements. They are embedded completely in elastomeric material. The strengthening elements of these reinforcing plies have the form, for example, of fabric or of calendered, continuously coiled strengthening elements.

In pneumatic vehicle tires, cords are used as strengthening elements for example in the bead region, as carcass material, for belt plies, and in the belt bandage.

A cord for the purposes of this patent application consists of at least 2 multifilament yarns which are twisted with one another.

The belt bandage in pneumatic vehicle tires, especially in the case of high-speed use, serves for preventing lifting of the tire as a result of the centrifugal forces that occur in driving operation. In a pneumatic vehicle tire, which generally has an inner layer impervious to air, a radial carcass comprising strengthening elements and extending from the crown region of the tire through the sidewalls into the bead region, where it is anchored usually by entwining of bead cores of high tensile strength, a radially outward tread having profile grooves, and a belt, the bandage is arranged between belt and tread. The belt bandage may have one or more plies, covers at least the edges of the belt and contains strengthening elements running parallel and essentially in circumferential direction in the form of cords embedded into a rubber mixture. In tire production, the belt bandage is applied in the form of plies, strips or individual strengthening elements, with strengthening elements embedded into an unvulcanized rubber mixture, which are wound or coiled onto the belt. The strengthening elements for such plies are embedded into rubber such that, for example, an array of substantially parallel, thread-shaped strengthening elements, which have generally been subjected to pretreatment by thermal means and/or with an impregnation in a manner known to the person skilled in the art for better adhesion to the embedding rubber, run in longitudinal direction through a calender or an extruder for ensheathing with the rubber mixture. An alternative is to use strengthening elements which have been adhesively impregnated and can be processed without a calendered adhesion mixture. In the course of shaping and of vulcanization of the tire, the tire, as a result of the lifting, generally stretches by up to 2% in the shoulder region and by up to 4% in the middle region compared to the unvulcanized green tire when said green tire is wound on a flat drum. Accordingly, the strengthening element used in the belt bandage is supposed advantageously to permit this lifting, in other words be stretchable initially with relatively low application of force, and yet after this initial stretching of up to 4% is to be stretchable only with a higher application of force, for high-speed operability. In a force-elongation diagram, accordingly, the strengthening element is to have a relatively flat profile up to an elongation of 4%, and a steeper profile thereafter.

The belt bandage has one or more plies, covers the edges of the belt, and comprises strengthening elements running parallel and approximately in circumferential direction, in the form of cords embedded into rubber. “Approximately in circumferential direction” refers to an angle of 0° to 5° in relation to the circumferential direction of the tire.

Known from WO 2014182265 A1 is a pneumatic vehicle tire whose belt bandage includes strengthening elements made of polyamide 6.6.

U.S. Pat. No. 3,343,363 A discloses twisted polyamide 6.6 filaments, yarns and cords as strengthening elements, as reinforcing material for tires, which have an initial modulus of between 25 and 60 g/d and a tenacity of greater than 7.0 g/d at room temperature. The initial modulus values are determined according to ASTM A1380-61T.

U.S. Pat. No. 3,849,976 A discloses polyamide 6.6 cords having two or more multifilament yarns with an L₅ modulus of greater than 60 g/d as reinforcing material for tires, these cords having been obtained by high-tension stretching at high temperatures.

U.S. Pat. No. 4,284,117 A discloses twisted nylon, polyester, rayon, and aramid yarns as strengthening elements of the belt bandage of pneumatic vehicle tires.

U.S. Pat. No. 5,115,853 A discloses nylon cords with a 420 d×2 (470 dtex×2) construction and a cord twist rate of less than 276 t/m, which are used in the belt bandage of pneumatic vehicle tires.

From the prior art it is known practice to increase the initial modulus or LASE (Load At Specified Elongation) of polyamide cords by subjecting them to hot stretching at comparatively high temperatures. To conserve the resulting properties even after relaxation (conditioned with free cut ends under laboratory conditions), it has hitherto been necessary to expose the PA 6.6 yarns or cords to temperature conditions of higher than 250° C. A disadvantage, however, is that under the above conditions, the cords become rigid/brittle and therefore suffer more rapid fatigue on exposure to cyclical compressive stress and bending stress.

It is the object of the invention to provide a reinforcing ply for articles composed of elastomeric material, said ply having strengthening elements composed of polyamide 6.6 with a comparably high modulus from 4% elongation, but which are more fatigue-resistant with respect to cyclical compressive stress and bending stress exposure. It is further the object of the invention to provide a pneumatic vehicle tire which has an aforesaid reinforcing ply and which exhibits improved high-speed properties and improved rolling resistance.

The object is achieved in relation to the reinforcing ply in that the raw yarn composed of polyamide 6.6 has a tenacity which, at an elongation of 4%, is within a range from 1.35 cN/dtex to 1.60 cN/dtex, in that the cord has a tenacity which, at an elongation of 4%, is within a range from 1.2 cN/dtex to 2 cN/dtex, and in that the cord has a thermal shrinkage at 177° within a range of 4.0%-7.0%, wherein the tenacity in accordance with ASTM D885-16 and the thermal shrinkage at 177° C. are determined under a pre-tension of 0.045 g/dtex with an exposure time of two minutes.

“Raw yarn” refers to a multifilament yarn which has not yet undergone hot stretching. “Cord” refers to strengthening elements with multifilament yarns which have already gone through the operation of hot stretching, including impregnation.

A reinforcing ply is made whose cords composed of polyamide 6.6 which on elongation by 4% have a higher modulus of elasticity than comparable cords, but which are more fatigue-resistant with respect to cyclical compressive stress and bending stress exposure. These properties are especially suitable for this reinforcing ply to be used in a vehicle tire, more particularly as a belt bandage, since the requisite elongation of up to around 3% is still retained for tire production, whereas, on higher elongations, higher forces have to be applied, this being advantageous for the high-speed operation of the tire.

The comparative values hereinafter for the tenacity of a strengthening element composed of polyamide 6.6 with a construction of 1400×2 at 4% elongation show the advantage of a higher tenacity of the strengthening element (B) used in a reinforcing ply of the invention, by comparison with a standard strengthening element (A) in a prior-art reinforcing ply:

TABLE 1

| | | |
|---|---|---|
| A | 1400x2 | 29N = 1.0 cN/dtex |
| B | 1400x2 | 35N = 1.3 cN/dtex |

Surprisingly, the cords of polyamide 6.6 for the reinforcing ply of the invention are obtained by virtue of the fact that the raw yarn used, composed of polyamide 6.6, has a tenacity which, at an elongation of 4%, is within a range from 1.35 cN/dtex to 1.60 cN/dtex, and that this raw yarn is stretched in a range of greater than 5% and less than 12% at temperatures between 230° C. and 250° C. and is coiled onto suitable spools with a tension of between 150 g and 500 g per strengthening element. As a result, the properties gained by means of the stretching operation are also retained in the strengthening element wound onto the spool, since the strengthening element is unable to relax and can be used in the tire without the relaxation, which always implies a loss of modulus.

The force-elongation data for the cords are determined in accordance with D885-16, after conditioning of the yarns on spools for 24 hours at 24° C. and a relative atmospheric humidity of 55%. After conditioning, the cords are tested within 1 minute after having been unwound from the spool.

These cords have a tenacity at 4% elongation of from 1.2 cN/dtex to 2.0 cN/dtex and a thermal shrinkage at 177° C. of from 4% to 7%. The tenacity at 4% elongation of from 1.2 cN/dtex to 2.0 cN/dtex corresponds to a modulus of 30.6 g/dtex to 51 g/dtex (34 g/d to 56.7 g/d).

The module values are calculated as follows: tenacity at 4% elongation×25, to give the required tenacity for 100% elongation.

The tenacity at 4% elongation [cN/dtex] is: tensile force at 4% elongation [cN]/linear density [dtex], employing the linear density of the entire strengthening element.

The linear density of the entire strengthening element is computed from the sum total of the linear densities of the multifilament yarns in the cord. Example: A cord with a 700 dtex×2 construction has a linear density of 1400 dtex for the entire strengthening element.

The thermal shrinkage of yarns and cords was determined using a shrinkage measurement device from the manufacturer Testrite under a pre-tension of 0.045 g/dtex at 177° C. with an exposure time of 2 minutes.

It is useful if the raw yarn composed of polyamide 6.6 has a tenacity which, at an elongation of 4%, is within a range from 1.35 cN/dtex to 1.50 cN/dtex. If the forces were even higher, it could lead to problems during mold introduction.

It is useful if the cord has a linear density of from 300 to 4000 dtex. This linear density range represents an advantageous balance between strength on the one hand and rolling resistance and costs on the other. If the linear density were too low, and hence if the multifilament yarn were too thin, the resulting strength would be too low. If the multifilament yarn were too thick, it would be detrimental to the rolling resistance of the tire and to the costs.

It is advantageous if the twist factor α of the cord is within a range from 100 to 250, preferably within a range from 120 to 180, where α=twist [t/m]·linear density [tex]/1000)^{1/2}. The twist factor is a measure of the end-twisting per meter of the cord, relative to the linear density of the cord. The twist factor is a measure of the twisting per meter of the multifilament yarn, based on the linear density of the multifilament yarn. This twist factor represents an advantageous balance in terms of fatigue resistance and strength. A lower twist factor would be detrimental to the fatigue resistance, while a higher twist factor would imply lower strength on the part of the strengthening element.

It is useful if the cord has a ×2 or ×3 construction. A cord composed of 2 or 3 yarns has better fatigue resistance than a twisted multifilament yarn. In the case of constructions higher than ×3, there is a disadvantageously sharp increase in the twisting costs, while other properties, such as the tenacity, for example, may suffer a disadvantageous drop.

In a first particularly suitable embodiment of the invention, each strengthening element of the reinforcing ply is a cord composed of two multifilament yarns twisted with one another and each having a linear yarn density of 1400 dtex. The construction of the cord is therefore 1400×2. The cord has a tenacity which, at an elongation of 4%, is within a range from 1.3 cN/dtex to 1.4 cN/dtex. The cords are arranged in the reinforcing ply preferably in a density of 90 epdm. As a result of the increased modulus of the PA6.6 cord, by comparison with the prior art, it can be arranged in a lower density in the reinforcing ply, thereby simplifying the production of this ply and likewise achieving a cost advantage on the basis of the reduced use of strengthening elements. There is likewise a lower risk of the semi-finished product being damaged while being cut to the required strip width.

In a second particularly suitable embodiment of the invention, each strengthening element of the reinforcing ply is a cord composed of two multifilament yarns twisted with one another and each having a linear yarn density of 470 dtex. The construction of the cord is therefore 470×2. The cord has a tenacity which, at an elongation of 4%, is within a range from 1.6 cN/dtex to 1.7 cN/dtex. The cords are arranged in the reinforcing ply preferably in a density of 90 to 100 epdm. As a result of the increased modulus of the PA6.6 cord, by comparison with the prior art, it can be arranged in a lower density in the reinforcing ply, thereby simplifying the production of this ply and likewise achieving a cost advantage on the basis of the reduced use of strengthening elements. There is likewise a lower risk of the semi-finished product being damaged while being cut to the required strip width.

In a third particularly suitable embodiment of the invention, each strengthening element of the reinforcing ply is a cord composed of two multifilament yarns twisted with one another and each having a linear yarn density of 350 dtex. The construction of the cord is therefore 350×2. The cord has a tenacity which, at an elongation of 4%, is 1.9 cN/dtex. The cords are arranged in the reinforcing ply preferably in a density of 110 to 130 epdm. As a result of the increased modulus of the PA6.6 cord, by comparison with the prior art, it can be arranged in a lower density in the reinforcing ply, thereby simplifying the production of this ply and likewise achieving a cost advantage on the basis of the reduced use of strengthening elements. There is likewise a lower risk of the semi-finished product being damaged while being cut to the required strip width.

It is advantageous if the reinforcing ply is a belt bandage ply wherein the strengthening elements are wound in the form of rubberized fabric strips or as rubberized fabric or is spirally coiled in the form of individual cords or as rubberized strips which have a plurality of parallel individual cords. The polyamide 6.6 cord has physical properties which make it especially suitable for use in a belt bandage.

Alternatively, however, the reinforcing ply may likewise be a bead reinforcement such as a chipper or flipper.

The invention is achieved in relation to the pneumatic vehicle tire by said tire having an above-described rubberized reinforcing ply. The pneumatic vehicle tire features improved rolling resistance. In the case of a higher density of strengthening elements in the reinforcing ply, the pneumatic vehicle tire likewise exhibits improved high-speed performance.

Tire tests were conducted with an automobile tire of size 225/45 R17, where the belt bandage consists of 2 coiled reinforcing plies. Automobile tires of identical construction were employed for these tests, with just the belt bandage being varied. The reinforcing plies of the invention have strengthening elements made of polyamide 6.6 with a 1400×2 construction, arranged in a density of 90 epdm in the reinforcing ply. As a comparison, prior-art reinforcing plies were tested, having strengthening elements made of standard polyamide 6.6 with a 1400×2 construction in a density of 110 epdm.

Table 2 below shows the results of these tests:

TABLE 2

| | Prior-art | Invention |
|---|---|---|
| | reinforcing ply | Reinforcing ply |
| | 1400x2, 110 epdm | 1400x2, 90 epdm |
| Strength at 4% elongation | 319 N/cm | 315 N/cm |
| Rolling resistance | 9.81 kg/t (=100%) | 9.68 kg/t (=101.3%) |

It can be seen that the strength at 4% elongation of the reinforcing ply of the invention, in spite of a markedly lower density of strengthening elements, is about the same as that of the prior-art reinforcing ply. It can likewise be seen that advantages are won in terms of the rolling resistance. The prior-art reference tire has a rolling resistance of 100%, whereas the tire with the reinforcing ply of the invention has attained 101.3%. Higher % figures represent better rolling resistance.

1.-12. (canceled)

13. A rubberized reinforcing ply for articles composed of elastomeric material, wherein the reinforcing ply comprises a multiplicity of strengthening elements which are in parallel and spaced apart, and wherein each strengthening element is a cord which is end-twisted from at least two twisted multifilament yarns composed of polyamide 6.6;
wherein raw yarns composed of the polyamide 6.6 have a tenacity which, at an elongation of 4%, is within a range from 1.35 cN/dtex to 1.60 cN/dtex, wherein the cord has a tenacity which, at an elongation of 4%, is within a range from 1.2 cN/dtex to 2 cN/dtex, and wherein the cord has a thermal shrinkage at 177° within a range of 4.0%-7.0%; and,
wherein the tenacity in accordance with ASTM D885-16 and the thermal shrinkage at 177° C. are determined under a pre-tension of 0.045 g/dtex with an exposure time of two minutes.

14. The reinforcing ply as claimed in claim 13, wherein the cord has a linear density of from 300 to 4000 dtex.

15. The reinforcing ply as claimed in claim 13, wherein a twist factor α of each multifilament yarn or of the cord is within a range from 100 to 250, and wherein the α=twist [t/m]·(linear density [tex]/1000)^{1/2}.

16. The reinforcing ply as claimed in claim 13, wherein the raw yarns composed of polyamide 6.6 have a tenacity which, at an elongation of 4%, is within a range from 1.35 cN/dtex to 1.50 cN/dtex.

17. The reinforcing ply as claimed in claim 13, wherein the multifilament yarn has a thermal shrinkage at 177° C. within a range of 5.0%-6.5%.

18. The reinforcing ply as claimed in claim 13, wherein the cord has a ×2 or ×3 construction.

19. The reinforcing ply as claimed in claim 18, wherein the strengthening element is a cord composed of two multifilament yarns twisted with one another and each having a linear yarn density of 1400 dtex, and therefore has a 1400×2 construction, wherein the cord has a tenacity which, at an elongation of 4%, is within a range from 1.3 cN/dtex to 1.4 cN/dtex, and wherein the cords are arranged in the reinforcing ply in a density of 80-120 epdm.

20. The reinforcing ply as claimed in claim 18, wherein the strengthening element is a cord composed of two multifilament yarns twisted with one another and each having a linear yarn density of 470 dtex, and therefore has a 470×2 construction, wherein the cord has a tenacity which, at an elongation of 4%, is within a range from 1.6 cN/dtex to 1.7 cN/dtex, and wherein the cords are arranged in the reinforcing ply in a density of from 90-170 epdm.

21. The reinforcing ply as claimed in claim 18, wherein the strengthening element is a cord composed of two multifilament yarns twisted with one another and each having a linear yarn density of 350 dtex, and therefore has a 350×2 construction, wherein the cord has a tenacity which, at an elongation of 4%, is 1.9 cN/dtex, and wherein the cords are arranged in the reinforcing ply in a density of 110 to 200 epdm.

22. The reinforcing ply as claimed in claim 13, wherein the reinforcing ply is a belt bandage ply, and wherein the strengthening elements are wound in the form of rubberized fabric strips or as rubberized fabric or is spirally coiled in the form of individual cords or as rubberized strips which have a plurality of parallel individual cords.

23. The reinforcing ply as claimed in claim 13, wherein the reinforcing ply is a bead reinforcement such as a chipper or flipper.

24. A pneumatic vehicle tire which has a reinforcing ply as claimed in claim 13.
